(19) United States
(12) Patent Application Publication
(10) Pub. No.: US 2026/0113090 A1
(43) Pub. Date: Apr. 23, 2026

(54) Methods to Enable UL Side Information for CSI Feedback Enhancement

(71) Applicant: InterDigital Patent Holdings, Inc., Wilmington, DE (US)

(72) Inventors: Mohamed Amine Arfaoui, Montreal (CA); Heasung Kim, Austin, TX (US); Philip Pietraski, Jericho, NY (US); Guodong Zhang, Woodbury, NY (US); Asil Koc, Verdun (CA); John Kaewell, Jamison, PA (US)

(73) Assignee: InterDigital Patent Holdings, Inc., Wilmington, DE (US)

(21) Appl. No.: 18/920,503

(22) Filed: Oct. 18, 2024

(51) Int. Cl. H04B 7/06; H04W 24/10; H04W 72/21

(52) U.S. Cl. CPC H04B 7/0626; H04W 24/10; H04W 72/21

(57) ABSTRACT

A wireless transmit/receive unit (WTRU) may receive network assistance information. The WTRU may determine a downlink channel state information (CSI) based one on more downlink reference signals (RSs). The WTRU may determine a value associated with an uplink/downlink (UL/DL) channel relation based on the network assistance information and measurements performed on the one or more downlink RSs. The WTRU may send a CSI feedback report, wherein the CSI feedback report is based on the measurements performed on the one or more downlink RSs and/or the associated value that quantifies the UL/DL channel relation. The associated value that quantifies UL/DL channel relation indicates a relation between an uplink channel and a downlink channel associated with the one or more downlink RSs. In an example, the processor is configured to determine a CSI compression ratio for the CSI feedback report based on the associated value that quantifies the UL/DL channel relation.

### BACKGROUND

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (e.g., ‘data’), without being explicitly programmed (e.g., ‘configuring a set of rules’). ML can be considered as a subset of AI. Different ML paradigms may be envisioned based on the nature of data or feedback available to the learning algorithm. In an example, a supervised learning approach may involve learning a function that maps input to an output based on labeled training example, wherein each training example may be a pair consisting of an input and its corresponding output. In an example, an unsupervised learning approach may involve detecting patterns in the data with no pre-existing labels. In an example, a reinforcement learning approach may involve performing sequence of actions in an environment to maximize the cumulative reward. In some solutions, it is possible to apply ML algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (e.g., with no labeled training data) and supervised learning (e.g., with only labeled training data).

Deep learning refers to a class of ML algorithms that employ artificial neural networks, specifically, deep neural networks (DNNs), which were loosely inspired from biological systems. The DNNs are a special class of ML models that are inspired by the human brain wherein the input is linearly transformed and pass through non-linear activation function multiple times. DNNs consist typically of multiple layers where each layer consists of linear transformation and a given non-linear activation functions. The DNNs can be trained using the training data via back-propagation algorithm. Recently, DNNs have shown state-of-the-art performance in a variety of domains, e.g., speech, vision, natural language, wireless communication, etc., and for various ML settings (e.g., supervised, un-supervised, semi-supervised, etc.).

### SUMMARY

The following enables a wireless transmit/receive unit (WTRU) to measure the relation between the uplink (UL) and downlink (DL) channels, to configure the parameters of its WTRU-side artificial intelligence/machine learning (AI/ML)-based channel state feedback model and/or parameters of the allocations of the UL reference signals based on the measured relation, and to report the measured relation to the network (NW).

According to one example aspect, the disclosure relates to a wireless transmit/receive unit (WTRU) that includes a processor and a memory, that is configured to receive configuration information. The configuration information may include an indication of a plurality of pilots associated with uplink information. The WTRU may be configured to send to the network one or more sounding reference signals (SRSs) and/or at least one pilot of the plurality of pilots. The at least one pilot is selected based on information associated with a downlink transmission. The WTRU may be configured to receive network assistance information. The WTRU may be configured to determine a downlink channel state information (CSI) based on one or more downlink reference signals (RSs). The WTRU may be configured to determine a value associated with an uplink/downlink (UL/DL) channel relation based on the network assistance information and measurements performed on the one or more downlink RSs. The value associated with an UL/DL channel relation may be measured statistics that quantify an uplink/downlink (UL/DL) channel relation. The WTRU may be configured to send a CSI feedback report. In one example aspect, the CSI feedback report is based on the measurements performed on the one or more downlink RSs and/or the associated value of the that quantifies the UL/DL channel relation.

In an example, the associated value that quantifies UL/DL channel relation indicates a relation between an uplink channel and a downlink channel associated with the one or more downlink RSs. The processor is configured to adjust one or more parameters used to generate the CSI feedback report based on a comparison between the associated value that quantifies the UL/DL channel relation and one or more thresholds. The processor is configured to determine a CSI compression ratio for the CSI feedback report based on the associated value that quantifies the UL/DL channel relation. The processor is configured to determine an amount of CSI feedback payload for the CSI feedback report based on the associated value that quantifies the UL/DL channel relation. In an example, the CSI feedback report may include the associated value that quantifies the UL/DL channel relation. The processor is configured to generate the CSI feedback report via an artificial intelligence/machine learning (AI/ML) model. The one or more pilots associated with uplink information provide an indication of an uplink channel, and wherein the one or more pilots are selected by a network and the configuration information indicates how the WTRU is to use the one or more pilots. The configuration information may include an indication of a SRS resource allocation associated with the one or more SRSs, a resource allocation for downlink reference signals (RS), and/or a configuration associated with channel state information (CSI) feedback reporting. The network assistance information may include one or more CSI feedback components associated with an uplink channel, a compressed representation of a CSI estimate associated with the uplink channel, and/or one or more parameters associated with the uplink channel. The downlink CSI includes an indication of one or more of a downlink CSI estimate, a rank associated with the downlink CSI estimate, one or more eigenvectors associated with the downlink CSI estimate, a channel quality indicator (CQI), and/or a complete DL channel.

According to one example aspect, the disclosure relates to a method implemented in a WTRU, the method comprising receiving configuration information. The configuration information may include an indication of a plurality of pilots associated with uplink information. The method may comprise sending one or more SRSs and at least one pilot of the plurality of pilots. The at least one pilot is selected based on information associated with a downlink transmission. The method comprises receiving network assistance information. The method comprises determining a downlink CSI based on one or more downlink RSs. The method comprises determining a value associated with an uplink/downlink (UL/DL) channel relation based on the network assistance information and measurements performed on the one or more downlink RSs. In one example, the value associated with an UL/DL channel relation is measured statistics that quantify an uplink/downlink (UL/DL) channel relation based on the network assistance information and measurements performed on the one or more downlink RSs. The method comprises sending a CSI feedback report. In one example aspect, the CSI feedback report is based on the measurements performed on the one or more downlink RSs and/or the value of the measured statistics that quantify the UL/DL channel relation.

In an example, the associated value that quantifies UL/DL channel relation indicates a relation between an uplink channel and a downlink channel associated with the one or more downlink RSs. The processor is configured to adjust one or more parameters used to generate the CSI feedback report based on a comparison between the associated value that quantifies the UL/DL channel relation and one or more thresholds. The processor is configured to determine a CSI compression ratio for the CSI feedback report based on the associated value that quantifies the UL/DL channel relation. The processor is configured to determine an amount of CSI feedback payload for the CSI feedback report based on the associated value that quantifies the UL/DL channel relation. In an example, the CSI feedback report may include the associated value that quantifies the UL/DL channel relation. The processor is configured to generate the CSI feedback report via an artificial intelligence/machine learning (AI/ML) model. The one or more pilots associated with uplink information provide an indication of an uplink channel, and wherein the one or more pilots are selected by a network and the configuration information indicates how the WTRU is to use the one or more pilots. The configuration information may include an indication of a SRS resource allocation associated with the one or more SRSs, a resource allocation for downlink reference signals (RS), and/or a configuration associated with channel state information (CSI) feedback reporting. The network assistance information may include one or more CSI feedback components associated with an uplink channel, a compressed representation of a CSI estimate associated with the uplink channel, and/or one or more parameters associated with the uplink channel. The downlink CSI includes an indication of one or more of a downlink CSI estimate, a rank associated with the downlink CSI estimate, one or more eigenvectors associated with the downlink CSI estimate, a channel quality indicator (CQI), and/or a complete DL channel.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example downlink (DL) channel state information (CSI) generation/reconstruction mechanism with side Information at the network (NW).

FIG. 3 is a diagram illustrating an example DL CSI generation/reconstruction mechanism with uplink (UL) side information at the NW.

FIG. 4 is a diagram illustrating an example NW and WTRU procedures to exploit UL side information for CSI feedback enhancement.

FIG. 5 is a diagram illustrating an example procedure performed by a WTRU to measure the UL/DL channel relation and to report it to the NW.

FIG. 6 is a diagram illustrating an example CsiNet model architecture, with the UL side information added as input to the NW-side AI/ML model.

FIG. 7 is a diagram illustrating an example block error rate (BLER) vs signal-to-noise ratio (SNR) for spatial/frequency (SF) CSI compression with and without UL side information.

### DETAILED DESCRIPTION

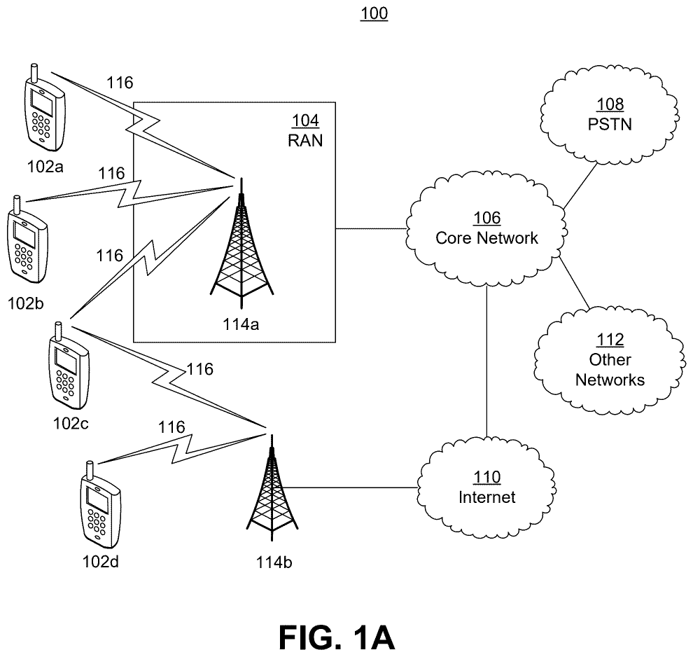

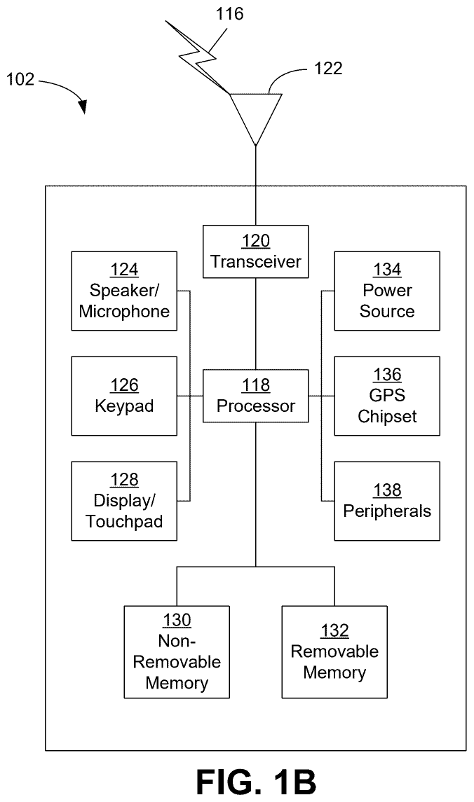

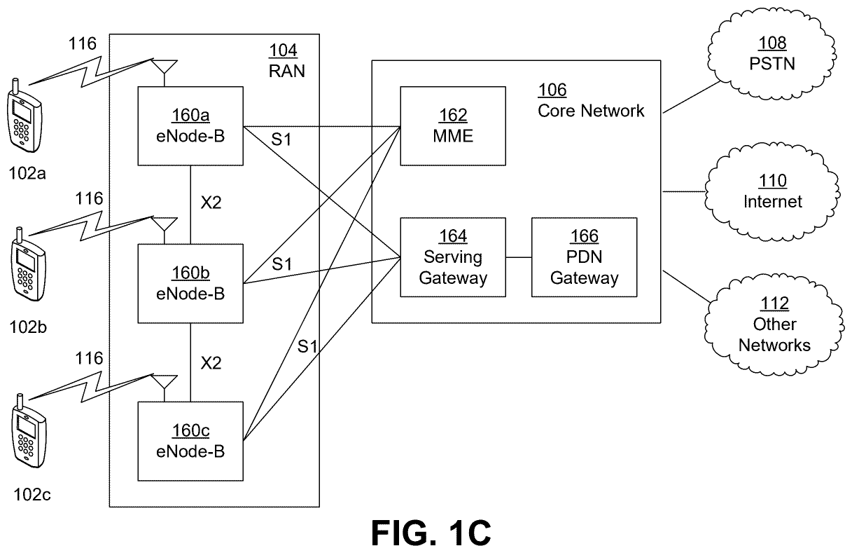

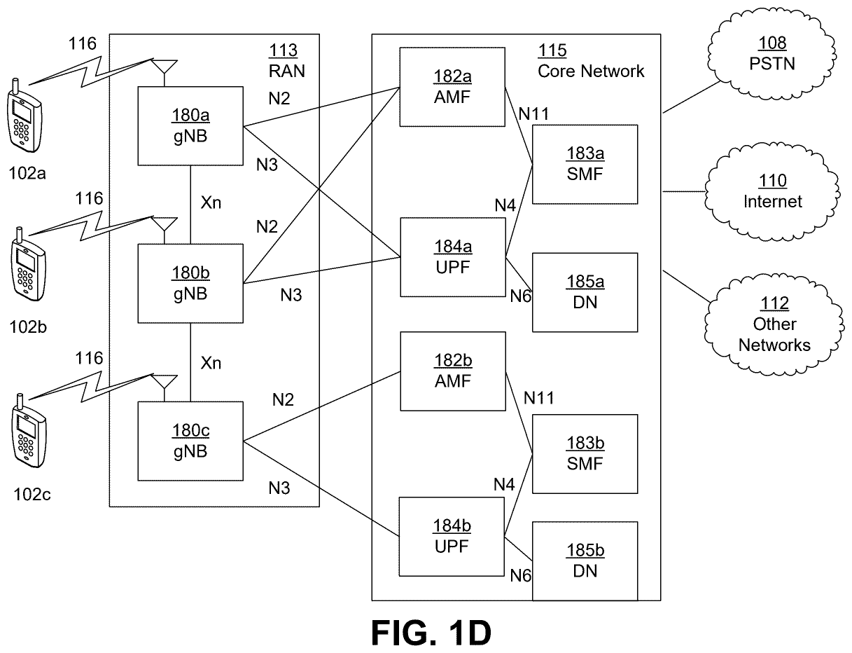

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For systems using artificial intelligence/machine learning (AI/ML) models for channel state feedback (CSF) functions, this invention describes methods for a wireless transmit/receive unit (WTRU) and a network to exploit the UL side information for channel state information (CSI) feedback enhancement.

Auto-encoders (AE) are specific class of deep neural networks (DNNs) that arise in context of un-supervised machine learning setting wherein the high-dimensional data is non-linearly transformed to a lower dimensional latent vector using the DNN based encoder, and the lower dimensional latent vector is then used to reconstructs the high-dimensional data using a non-linear decoder. The encoder may be represented as E(x; Wₑ) where x is the high-dimensional data and Wₑ represents the parameters of the encoder. The decoder may be represented as D(z; W_{d}) where z is the low-dimensional latent representation and W_{d} represents the parameters of the decoder. Further, using training data {x₁, . . . , x_{N}} the auto-encoder may be trained by solving the following optimization problem.

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem may be approximately solved using backpropagation algorithm. The trained encoder

$$E ( x ; {W}_{e}^{tr} )$$

can be used to compress the high-dimensional data and the trained decoder

$$D ( z ; {W}_{d}^{tr} )$$

can be used to reconstruct the high-dimensional data from the latent representation.

Channel state feedback (CSF) functions define a series of functions implemented at the WTRU side to enable the estimation of the channel state information (CSI) and its transmission to the network (NW). By doing so, the NW can exploit the received CSI feedback to apply some link adaptation functions to the WTRU, e.g., appropriate modulation and coding scheme (MCS) and precoding, beam management, power allocation, resource block (RB) allocation, etc. The CSF functions include primally the CSI estimation, from which the WTRU may generate a CSI report containing some measurements indicators of the channel quality, such as channel quality indicator (CQI), precoding matrix indicator (PMI), rank indicator (RI), and layer indicator (LI), etc., for 5G new radio (NR). CSF functions may be extended to include CSI prediction, CSI compression, as well as combinations between these two functions. The details of these CSF functions may be provided herein.

Example mechanisms and frameworks for using artificial intelligence/machine learning (AI/ML) based approaches at the air interface level for CSI feedback enhancement are described herein. For example, spatial/frequency (SF) CSI compression and temporal CSI prediction may be used. SF CSI compression may define the operation of compressing the CSI estimates in the SF domain by the WTRU (e.g., using AEs defined herein) to a quantized-binary representation with a predefined feedback size (e.g., in bits) and transmitting it to the NW. The NW, in turn, may reconstruct the SF CSI estimates by decompressing the received CSI feedback from the WTRU. Temporal CSI prediction may define the operation of predicting posterior SF CSI, either by the WTRU or by the NW, from historical SF CSI estimates. The two cases may be within the CSF functions and/or may be implemented after the CSI estimation function.

Described herein may be mechanisms and frameworks for using AI/ML based approaches at the air interface level, for example, for temporal CSI prediction, SF CSI compression, temporal/spatial/frequency (TSF) CSI compression, CSI compression plus prediction, and/or joint CSI compression and prediction. TSF CSI compression may define the operation of generating a quantized-binary representation of the CSI with a predefined feedback size (e.g., in bits) based on the current and the prior SF CSI estimates, and then transmitting it to the NW. The NW, in turn, may reconstruct the current SF CSI estimates by jointly incorporating the reconstructed prior SF CSI estimates and the received CSI feedback from the WTRU. CSI compression plus prediction may define the operation of concatenating the SF/TSF CSI compression and the temporal CSI prediction operation in a cascaded manner. The order of concatenation, e.g., compression first or prediction first, may be interchangeable. Joint CSI compression and prediction may define the operation of jointly performing CSI compression and prediction within a single function block. Specifically, joint CSI compression and prediction may define the operation of generating a quantized-binary representation of the CSI with a predefined feedback size (e.g., in bits) based on the current and the prior SF CSI estimates, and then transmitting it to the NW. The NW, in turn, may reconstruct the posterior SF CSI estimates by jointly incorporating the reconstructed prior SF CSI estimates and the received CSI feedback from the WTRU.

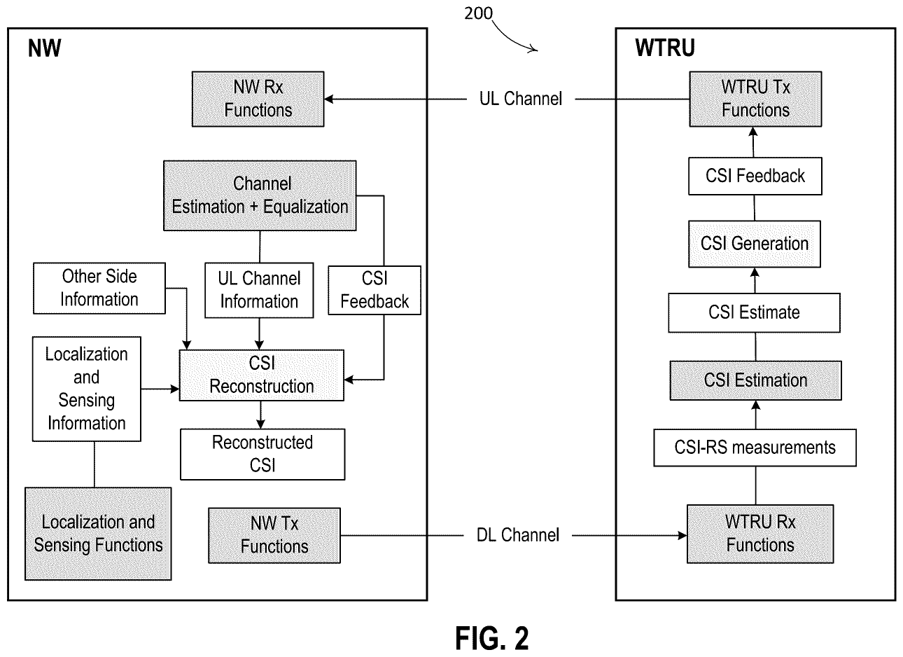

The CSI feedback provided by the WTRU may be used by the NW to design a DL transmission (e.g., scheduling, MCS, beam management, DL precoders, etc.). Side information presents possible information, other than the CSI feedback, that helps the NW in designing the DL transmission. Side information may include information about the WTRU (e.g., location of the WTRU) and/or the communication environment (e.g., radio channels, site layout and geometry, materials, blockages, etc.). As presented in FIG. 2, examples of side information may include UL channel estimated at the NW, since it might be correlated with the DL channel (e.g., either in time-division duplexing (TDD) or frequency division duplexing (FDD) systems). FIG. 2 is a diagram 200 illustrating an example downlink (DL) channel state information (CSI) generation/reconstruction mechanism with side Information at the network (NW).

Examples of side information may include localization and sensing information, for example, that may be radio or multimodal. Examples of side information may include site information (e.g., geometry, layout, materials, etc.).

The CSI feedback provided by the WTRU may be used by the NW to acquire and recover the DL CSI at the NW, which may then be used by the NW to design the DL transmission (e.g., scheduling, MCS, beam management, DL precoders, etc.). DL CSI feedback enhancement includes DL CSI compression enhancement at the WTRU (e.g., lower dimension and/or resolution latent representations of the DL CSI, etc.), DL CSI feedback reporting enhancement (e.g., lower DL RSs overhead, lower DL CSI feedback overhead, etc.), higher construction accuracy at the network, etc. Legacy AI/ML solutions for CSI feedback enhancement suffer from some limitations, including quantization-induced errors, high signaling overhead, especially with large multiple input multiple output (MIMO) systems, high computational complexity at the WTRU and the NW, etc. Therefore, a solution that enables the exploration of UL side information for DL CSI feedback enhancement is desired.

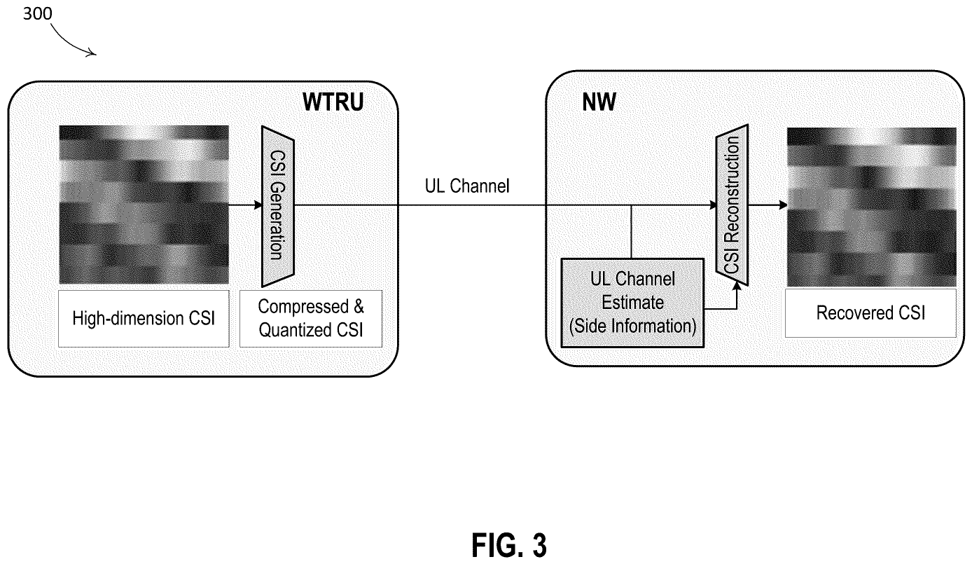

The following provides an overview of methods to enable uplink (UL) side information for CSI feedback enhancement. FIG. 3 is a diagram 300 illustrating an example DL CSI generation/reconstruction mechanism with UL side information at the NW. The UL CSI that is embedded within the UL channel that carries the CSI feedback information to the NW along with other data and signals (e.g., if present) may be beneficial for the DL CSI reconstruction at the NW. Specifically, as depicted in FIG. 3, due to the correlations that may exist between the DL and UL channels, the UL side information embedded in the UL channel, when inputted in the DL CSI reconstruction function at the NW, may help in providing better DL CSI reconstruction accuracy at the NW, lower CSI feedback overhead resulting from the CSI feedback report or the channel state information reference signal (CSI-RS) transmission, as well as lower computational complexity at the WTRU and the NW.

For the WTRU and the NW to exploit the UL side information for CSI feedback enhancement, a mechanism to measure statistics that quantify the relation between the UL and DL channels is described herein. As such, the examples described herein enable the WTRU to measure some statistics that quantify the relation between the UL and DL channels, by the means of feedback from the NW, and to report that relation to the NW. The examples described herein may apply to CSI feedback functions that are based on two-sided AI/ML models, wherein one side is residing at the WTRU, and one side is residing at the NW, such as CSI compression, joint CSI estimation and compression, joint CSI prediction and compression, joint CSI estimation, prediction, and compression, etc., and to CSI feedback functions that are based on one-sided AI/ML models residing at the NW, such as NW-side CSI prediction.

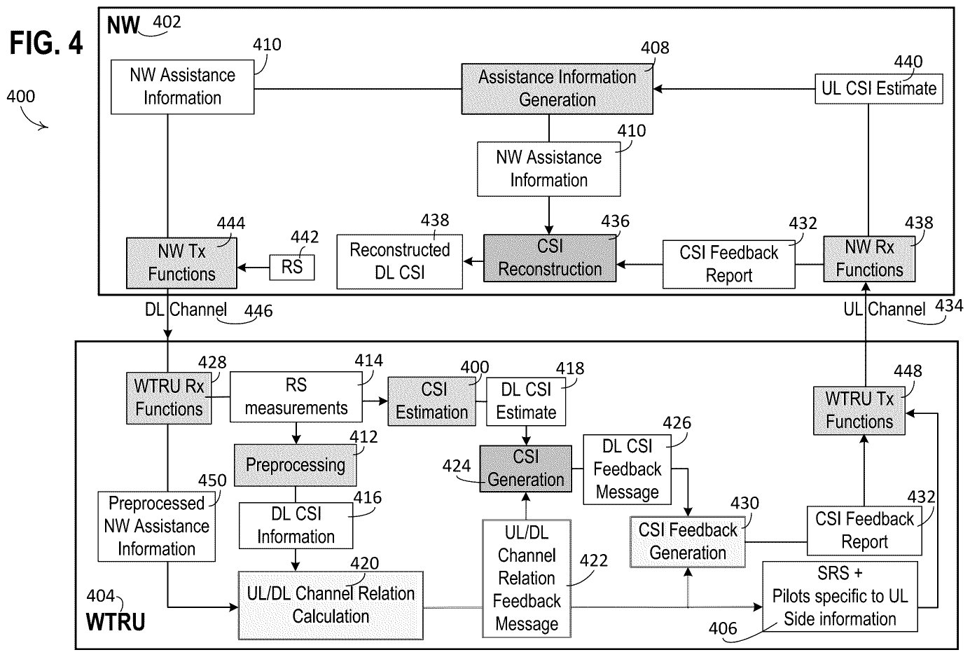

FIG. 4 is a diagram 400 illustrating an example NW and WTRU procedure to exploit UL side information for CSI feedback enhancement. As depicted in FIG. 4, the NW 402 may configure the WTRU 404 to transmit pilot signals 406 for UL channel sounding. The pilot signals may be sounding reference signals (SRS) and/or pilots specific to UL side information. The NW 402 may configure the WTRU 404 to span the SRS in the frequency domain over the bandwidth of interest (e.g., the WTRU 404 may be configured to select specific subcarriers, by the means of the transmission comb type (TC) parameter, that are close to the DL channel allocation). The pilots specific to UL side information may be pilot signals that have higher density and/or power compared to SRS. The WTRU 404 may be configured to populate these pilot signals with a non-uniform density in the frequency domain (e.g., the closest UL subcarriers to the DL channel allocation). In a training phase, the NW 402 may configure the WTRU 404 to use different subcarriers as the system learns to optimize the choice of subcarriers to use.

The NW 402 may receive the SRS, the pilots specific to UL side information, and all available UL signals (e.g., data, demodulation reference signals, etc.), and may generate NW assistance information 410 to be transmitted to the WTRU 404 as feedback. For instance, the NW 402 may estimate the UL CSI 440 using the UL pilots, inputs the UL CSI estimate to the assistance information generation block 408, wherein the NW 402 compute statistics and/or UL CSI feedback quantities associated to the UL CSI and include the statistics and/or UL CSI feedback quantities in the NW assistance information 410, and/or transmit the NW assistance information 410 to the WTRU 404. The statistics and UL CSI feedback quantities that are inserted in the NW assistance information 410 may include CSI feedback components (e.g., PMI, CQI, RI, etc.,), and/or explicit or latent representation of the UL CSI estimate, and/or the best matched UL precoder.

The WTRU 404 may receive the NW assistance information 410 from the NW 402. Depending on the content of the NW assistance information, the WTRU 404 may apply some preprocessing. For example, the WTRU 404 may reconstruct the UL CSI based on the compressed representation of the UL CSI in the NW assistance information 410 or may reconstruct the UL precoder based on the received PMI or the compressed representation of the UL precoder in the NW assistance information 410. The WTRU 404 may receive CSI-RS, apply preprocessing 412 to the measured RS 414, and/or generate the DL CSI information 416. The DL CSI information may include explicit or latent representation of DL CSI estimate. The DL CSI information may include a rank of the estimated DL channel matrix. The DL CSI information may include DL precoder (e.g., eigenvectors) obtained from the DL CSI estimate. The DL CSI information may include MCS.

Based on the received NW assistance information and the DL CSI information, the WTRU 404 may compute measured statistics that quantify the UL/DL channel relation 420 between the preprocessed NW assistance information 450 (e.g., which may include UL CSI information) and the generated DL CSI information. The measured statistics may provide information about UL/DL channel relation (e.g., the similarity and/or the correlation between the UL and DL CSI). The measured statistics may be either explicit or a latent representation of the UL/DL channel relation. Furthermore, the function that generates the measured statistics at the WTRU 404 may be configured by the NW 402 and/or the function may be an AI/ML model itself. The WTRU 404 may generate an UL/DL channel relation feedback message 422 that includes the measured statistics computed by the WTRU 404. In parallel, the WTRU 404 may perform CSI estimation 400, generate the DL CSI estimate 418 based on the measured RS 414, input the DL CSI estimate 418 to the WTRU's CSI generation block 424, and/or generate a DL CSI feedback message 426. The CSI generation block may include the WTRU-side AI/ML-based CSI feedback function. The WTRU 404 may adjust parameters of the CSI generation block based on the computed value of the measured statistics that quantify the UL/DL channel relation. For example, the WTRU 404 may determine (e.g., increase/reduce) the CSI compression ratio or may use all or part of the CSI feedback payload, for example, if the value of the measured statistics that quantify the UL/DL channel relation is lower or higher than one or more thresholds (e.g., thresholds that are configured by the network). The WTRU 404 may generate a CSI feedback report 432 based on the generated DL CSI feedback message 426 and/or the generated UL/DL channel relation feedback message 422.

The WTRU 404 may map the generated CSI feedback report 432 to the UL resource elements (RE). The WTRU 404 may apply the UL precoder to the CSI feedback report, for example, if the WTRU 404 reconstructed the UL precoder from the NW assistance information, and if the WTRU 404 is configured to transmit the CSI feedback report through physical uplink shared channel (PUSCH). One of the triggers to transmit the CSI feedback report on PUSCH may be the absence of UL data to be transmitted from the WTRU 404 to the NW 402. Furthermore, the WTRU 404 may apply the UL precoder to the UL data and UL demodulation reference signal (DMRS), for example, if the WTRU 404 reconstructed the UL precoder from the NW assistance information, and if there is UL data to be transmitted from the WTRU 404 to the NW 402. The NW 402 may configure the WTRU 404 to span the UL data, UL DMRS, and/or the CSI feedback report, in the frequency domain over the bandwidth of interest (e.g., the closest UL subcarriers to the DL channel allocation).

From the NW 402 side, the NW 402 may extract the CSI feedback report 432 and recover the DL CSI feedback message and/or the UL/DL channel relation feedback message transmitted by the WTRU 404. The NW 402 may use the DL CSI feedback message, the UL/DL channel relation feedback message, and/or the UL side information hidden in the UL channel as input to its DL CSI reconstruction block. The DL CSI reconstruction block may include the NW-side AI/ML-based CSI feedback function. The NW 402 may use the UL side information hidden in the UL channel (e.g., either implicitly or explicitly) as input to its DL CSI reconstruction block. For instance, the NW 402 may input directly the UL DMRS and the UL data (e.g., if there is any), the NW assistance information 410, the SRS and the pilots specific to UL side information 406, and/or signals (e.g., all signals) present in the UL channel to its CSI reconstruction block. Otherwise, the NW 402 may estimate the UL channel using UL DMRS (e.g., if there is any), the NW assistance information 410, the SRS and the pilots specific to UL side information 406, and/or signals (e.g., all signals) present in the UL transmission. Then, the NW 402 may use the explicit UL channel as input to its DL CSI reconstruction block. For both cases, the NW 402 may recover the DL CSI estimate 438 from the output of its DL CSI reconstruction block 436.

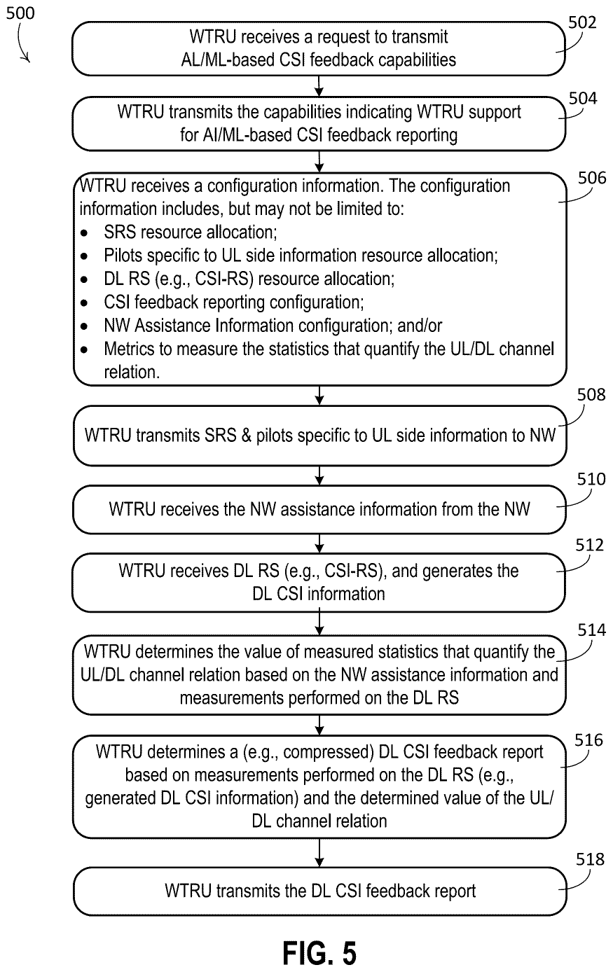

FIG. 5 is a diagram illustrating an example procedure 500 performed by a WTRU to measure statistics of the UL/DL channel relation and to report it to the NW. Examples of WTRU and NW procedures to exploit the UL side information for CSI feedback enhancement are described herein (e.g., the procedure 500 provides an example from the WTRU perspective). The NW can refer to any node in the network (e.g., gNB, another WTRU (e.g., sidelink, WTRU-to-WTRU direct communication), etc.).

A WTRU may receive (e.g., from NW) a request to transmit AI/ML-based CSI feedback capabilities at 502. The WTRU may transmit its capabilities to the NW by means of radio resource control (RRC) signaling. For example, the WTRU may transmit AI/ML-based CSI feedback capabilities indicating WTRU support for AI/ML-based CSI feedback reporting at 504.

The WTRU may receive a configuration information at 506 (e.g., from NW). The configuration information may include SRS resource allocation information (e.g., SRS periodicity, SRS locations, SRS density, etc.). The configuration information may include information about one or more pilots specific to UL side information resource allocation (e.g., periodicity, locations, density, etc.). The configuration information may include DL RS (e.g., CSI-RS) resource allocation information (e.g., RS periodicity, RS locations, RS density, etc.). The configuration information may include a CSI feedback reporting configuration. The CSI feedback reporting configuration may include reporting type (e.g., periodic, semi-persistent, or aperiodic). The CSI feedback reporting configuration may include report quantity (e.g., configuration of AI/ML-based CSI feedback report). The CSI feedback reporting configuration may include configuration of channel state feedback parameters (e.g., the number of CSI estimates used for CSI feedback reporting, CSI feedback payload, quantization parameters, etc.). The CSI feedback reporting configuration may include the signals and/or the uplink resource configuration/allocations that may carry the CSI feedback report (e.g., PUSCH, physical uplink control channel (PUCCH), RRC, uplink control information (UCI), medium access control-control element (MAC-CE)). The configuration information may include NW assistance information configuration. The configuration information may include metrics to measure the statistics that quantify the UL/DL channel relation.

The WTRU may receive the configuration information at 506 (e.g., from NW). The WTRU may receive the configuration through one or more of DCI, MAC-CE or RRC signaling.

The WTRU transmits SRS and pilots specific to UL side information to the NW at 508 (e.g., for UL channel sounding).

The WTRU may receive the NW assistance information from the NW at 510. The NW assistance information may include CSI feedback components (e.g., PMI, CQI, RI, etc.) of the UL channel. The NW assistance information may include either the full explicit representation of the UL CSI estimate or a compressed representation of the UL CSI estimate. The NW assistance information may include either the full explicit representation of the UL CSI precoder, or a compressed representation of the UL CSI precoder, or the best matched UL precoder. The NW assistance information may include parameters of the UL channel. The WTRU may apply preprocessing to the NW assistance information, for example, depending on the content in the NW assistance information. For example, the WTRU may reconstruct the UL CSI based on the compressed representation of the UL CSI in the NW assistance information (e.g., using configured AI/ML or non-AI/ML techniques) and/or the WTRU may reconstruct the UL precoder based on the received PMI or the compressed representation of the UL precoder in the NW assistance information (e.g., using configured AI/ML or non-AI/ML techniques).

The WTRU may receive DL RS (e.g., CSI-RS), and may generate the DL CSI information at 512. The DL CSI information may include a DL CSI estimate. The DL CSI information may include a rank of the estimated DL channel matrix. The DL CSI information may include a DL Precoder (e.g., eigenvectors), for example, obtained from the DL CSI estimate. The DL CSI information may include a CQI. The DL CSI information may include a complete DL channel.

The WTRU may determine the value of the measured statistics that quantify the UL/DL channel relation based on the NW assistance information and measurements performed on the DL RS at 514 (e.g., generated DL CSI information). The WTRU may determine a (e.g., compressed) DL CSI feedback report based on measurements performed on the DL RS (e.g., generated DL CSI information) and/or the determined value of the measured statistics that quantify the UL/DL channel relation at 516. The DL CSI feedback report may be generated by an AI/ML model or a hybrid AI/ML model. The WTRU may adjust some parameters of the CSI generation block based on the value of the measured statistics that quantify the UL/DL channel relation. In an example, the WTRU may determine (e.g., increase/reduce) the CSI compression ratio or may use all and/or part of the CSI feedback payload, if the value of the measured statistics that quantify the UL/DL channel relation is lower or higher than one or more threshold (e.g., thresholds that are configured by the network).

The WTRU may transmit the DL CSI feedback report to the NW at 518. The DL CSI feedback report may include the determined value of the measured statistics that quantify the UL/DL channel relation. The transmission of the DL CSI feedback report may be over resources determined from one or more of the value measured statistics that quantify the of the UL/DL channel relation and/or the parameter (e.g., compression ratio, feedback payload) of the DL CSI feedback report. The WTRU may transmit SRS and/or pilots specific to UL side information, and the configuration of the SRS and/or pilots specific to UL side information may be determined based on the value of the measured statistics that quantify the UL/DL channel relation and/or the DL CSI feedback report.

The following details an example procedure from the NW side. The NW may receive the SRS, the pilots specific to UL side information, and all available UL signals (e.g., data, demodulation reference signals, etc.), and may generate NW assistance information. The NW may estimate the UL CSI using the SRS, the pilots specific to UL side information, and all available UL signals (e.g., data, demodulation reference signals, etc.), compute UL CSI feedback quantities associated to the UL CSI, and/or include the UL CSI feedback quantities associated to the UL CSI in the NW assistance information. The UL CSI feedback quantities inserted in the NW assistance information may include CSI feedback components (e.g., PMI, CQI, RI, etc.) of the UL channel. The UL CSI feedback qualities inserted in the NW assistance information may include either the full explicit representation of the UL CSI estimate or a compressed representation of the UL CSI estimate. The UL CSI feedback qualities inserted in the NW assistance information may include either the full explicit representation of the UL CSI precoder, or a compressed representation of the UL CSI precoder, or the best matched UL precoder. The NW may transmit the NW assistance information to the WTRU. The NW may receive, from the WTRU, a DL CSI feedback report and/or the WTRU-determined value of the measured statistics that quantify the UL/DL channel relation.

The NW may determine the DL CSI estimate based on the DL CSI feedback report, the value of the measured statistics that quantify the UL/DL channel relation, the UL side information determined from SRS and/or pilots specific to UL side information, and/or UL side information determined from UL data transmission. In a first solution, the NW may input the UL DMRS and the UL data (e.g., if there is any), the NW assistance information, the SRS, the pilots specific to UL side information, and/or pilots (e.g., all pilots) present in the UL channel to its DL CSI reconstruction block. In a second solution, the NW may estimate the UL channel using UL DMRS (e.g., if there is any), the NW assistance information, the SRS, the pilots specific to UL side information, and/or pilots (e.g., all pilots) present in the UL transmission. Afterwards, the NW uses the explicit UL channel as input to DL CSI reconstruction block. The DL CSI reconstruction block may be an AI/ML model or a hybrid AI/ML model.

The NW may adjust and transmit to the WTRU the configuration of one or more of the CSI feedback payloads, the CSI feedback compression ratio, the CSI-RS allocations, the UL DMRS allocations, the SRS allocations, and/or the pilots specific to UL side information allocations based on some triggers. For example, the NW may configure the WTRU to use a specific pattern for UL pilots (e.g., SRS, pilots specific to UL side information, DMRS), in terms of pilot locations, density, and/or power. For example, the NW may configure the WTRU to use a specific UL precoder. For example, the NW may configure the WTRU to use customized grants that might cover the bandwidth of interest. The triggers may include if the WTRU-determined value of measured statistics of the UL/DL channel relation is higher or lower than one or more threshold. Accordingly, the NW may adapt (e.g., increase/reduce) the CSI feedback payload size or CSI compression ratio or the SRS and the pilots specific to UL side information allocations. The triggers may be associated with the performance feedback from the WTRU. Accordingly, the NW may increase or reduce the CSI feedback payload size, the CSI compression ratio, and/or the SRS and the pilots specific to UL side information allocations if the measured BLER is lower or higher than one or more thresholds.

The UL CSI that is embedded within the UL channel that carries the CSI feedback information to the NW along with other data and signals (e.g., if present) may be beneficial for the DL CSI reconstruction at the NW. Specifically, as depicted in FIG. 3, due to the correlations that may exist between the DL and UL channels, the UL side information embedded in the UL channel, when inputted in the DL CSI reconstruction function at the NW, may help in providing better DL CSI reconstruction accuracy at the NW, lower CSI feedback overhead resulting from the CSI feedback report or the CSI-RS transmission, and/or lower computational complexity at the WTRU and the NW.

The WTRU and the NW may exploit the UL side information for CSI feedback enhancement by developing a one or more procedures to measure statistics that quantify the relation between the UL and DL channels. These procedures enable the WTRU to measure some statistics that quantify the relation between the UL and DL channels, by the means of feedback from the NW, and to report those measured statistics to the NW. The solution applies to CSI feedback functions that are based on two-sided AI/ML models, wherein one side is residing at the WTRU, and one side is residing at the NW, such as CSI compression, joint CSI estimation and compression, joint CSI prediction and compression, joint CSI estimation, prediction, and compression, etc., and to CSI feedback functions that are based on one-sided AI/ML models residing at the NW, such as NW-side CSI prediction. FIG. 4 is a diagram 400 illustrating an example NW and WTRU procedure to exploit UL side information for CSI feedback enhancement. As depicted in FIG. 4, the NW 402 may configure the WTRU 404 to transmit pilot signals 406 for UL channel sounding. The pilot signals may be sounding reference signals (SRS) and/or pilots specific to UL side information. The NW 402 may configure the WTRU 404 to span the SRS in the frequency domain over the bandwidth of interest (e.g., the WTRU 404 may be configured to select specific subcarriers, by the means of the transmission comb type (TC) parameter, that are close to the DL channel allocation). The pilots specific to UL side information may be pilot signals that have higher density and/or power compared to SRS. The WTRU 404 may be configured to populate these pilot signals with a non-uniform density in the frequency domain (e.g., the closest UL subcarriers to the DL channel allocation). In a training phase, the NW 402 may configure the WTRU 404 to use different subcarriers as the system learns to optimize the choice of subcarriers to use.

The NW 402 may receive the SRS, the pilots specific to UL side information, and all available UL signals (e.g., data, demodulation reference signals, etc.), and may generate NW assistance information 410 to be transmitted to the WTRU 404 as feedback. For instance, the NW 402 may estimate the UL CSI 440 using the UL pilots, inputs the UL CSI estimate to the assistance information generation block 408, wherein the NW 402 compute statistics and/or UL CSI feedback quantities associated to the UL CSI and include the statistics and/or UL CSI feedback quantities in the NW assistance information 410, and/or transmit the NW assistance information 410 to the WTRU 404. The statistics and UL CSI feedback quantities that are inserted in the NW assistance information 410 may include CSI feedback components (e.g., PMI, CQI, RI, etc.,), and/or explicit or latent representation of the UL CSI estimate, and/or the best matched UL precoder.

The WTRU 404 may receive the NW assistance information 410 from the NW 402. Depending on the content of the NW assistance information, the WTRU 404 may apply some preprocessing. For example, the WTRU 404 may reconstruct the UL CSI based on the compressed representation of the UL CSI in the NW assistance information 410 or may reconstruct the UL precoder based on the received PMI or the compressed representation of the UL precoder in the NW assistance information 410. The WTRU 404 may receive CSI-RS, apply preprocessing 412 to the measured RS 414, and/or generate the DL CSI information 416. The DL CSI information may include explicit or latent representation of DL CSI estimate. The DL CSI information may include a rank of the estimated DL channel matrix. The DL CSI information may include DL precoder (e.g., eigenvectors) obtained from the DL CSI estimate. The DL CSI information may include MCS.

Based on the received NW assistance Information and the DL CSI information, the WTRU 404 may compute measured statistics that quantify the UL/DL channel relation 420 between the preprocessed NW assistance information 450 (e.g., which may include UL CSI information) and the generated DL CSI information. The measured statistics may provide information about UL/DL channel relation (e.g., the similarity and/or the correlation between the UL and DL CSI). The measured statistics may be either explicit or a latent representation of the UL/DL channel relation. Furthermore, the function that generates the measured statistics at the WTRU 404 may be configured by the NW 402 and/or the function may be an AI/ML model itself. The WTRU 404 may generate an UL/DL channel relation feedback message 422 that includes the measured statistics computed by the WTRU 404. In parallel, the WTRU 404 may perform CSI estimation 400, generate the DL CSI estimate 418 based on the measured RS 414, input the DL CSI estimate 418 to the WTRU's CSI generation block 424, and/or generate a DL CSI feedback message 426. The CSI generation block may include the WTRU-side AI/ML-based CSI feedback function. The WTRU 404 may adjust parameters of the CSI generation block based on the computed value of the measured statistics that quantify the UL/DL channel relation. For example, the WTRU 404 may determine (e.g., increase/reduce) the CSI compression ratio or may use all or part of the CSI feedback payload, for example, if the value of the measured statistics that quantify the UL/DL channel relation is lower or higher than one or more thresholds (e.g., thresholds that are configured by the network). The WTRU 404 may generate a CSI feedback report 432 based on the generated DL CSI feedback message 426 and/or the generated UL/DL channel relation feedback message 422.

The WTRU 404 may map the generated CSI feedback report to the UL resource elements (RE). The WTRU 404 may apply the UL precoder to the CSI feedback report, for example, if the WTRU 404 reconstructed the UL precoder from the NW assistance information, and if the WTRU 404 is configured to transmit the CSI feedback report through physical uplink shared channel (PUSCH). One of the triggers to transmit the CSI feedback report on PUSCH may be the absence of UL data to be transmitted from the WTRU 404 to the NW 402. Furthermore, the WTRU 404 may apply the UL precoder to the UL data and UL demodulation reference signal (DMRS), for example, if the WTRU 404 reconstructed the UL precoder from the NW assistance information, and if there is UL data to be transmitted from the WTRU 404 to the NW 402. The NW 402 may configure the WTRU 404 to span the UL data, UL DMRS, and/or the CSI feedback report, in the frequency domain over the bandwidth of interest (e.g., the closest UL subcarriers to the DL channel allocation).

From the NW 402 side, the NW 402 may extract the CSI feedback report 432 and recover the DL CSI feedback message and/or the UL/DL channel relation feedback message transmitted by the WTRU 404. The NW 402 may use the DL CSI feedback message, the UL/DL channel relation feedback message, and/or the UL side information hidden in the UL channel as input to its DL CSI reconstruction block. The DL CSI reconstruction block may include the NW-side AI/ML-based CSI feedback function. The NW 402 may use the UL side information hidden in the UL channel (e.g., either implicitly or explicitly) as input to its DL CSI reconstruction block. For instance, the NW 402 may input directly the UL DMRS and the UL data (e.g., if there is any), the NW assistance information 410, the SRS and/or the pilots specific to UL side information 406, and/or signals (e.g., all signals) present in the UL channel to its CSI reconstruction block. Otherwise, the NW 402 may estimate the UL channel using UL DMRS (e.g., if there is any), the NW assistance information 410, the SRS and the pilots specific to UL side information 406, and/or signals (e.g., all signals) present in the UL transmission. Then, the NW 402 may use the explicit UL channel as input to its DL CSI reconstruction block. For both cases, the NW 402 may recover the DL CSI estimate 438 from the output of its DL CSI reconstruction block 436.

The following details an example procedure of AI/ML for channel state feedback CSF reporting.

A WTRU may be configured to employ an AI/ML model for CSI feedback reporting. The application stage entails CSI feedback reporting. The input data stage entails DL CSI estimate (e.g., full raw channel or eigenvectors of the raw channel). The preprocessing stage entails extracting the CSI-RS from the received signals by using the CSI-RS resource allocations. The preprocessing stage entails division by (or multiplication by conjugate of) the known CSI-RS symbols. The preprocessing stage entails applying an interpolation and/or a 2D filtering to the CSI-RS carrying REs. The preprocessing stage entails applying SVD to the estimated full DL raw channel if the CSI feedback reporting is based on the eigenvectors of the estimated full DL raw channel. The preprocessing stage entails resizing the input data shape. The preprocessing stage entails concatenation of the real and imaginary parts to obtain the real-valued input to the AI/ML model.

The AI/ML model stage entails CSI compression. For the CSI feedback, various AI/ML models exist for CSI compression including CsiNet, EVCsiNet, etc. Based on the autoencoder architecture, the AI/ML models for CSI compression employ an encoder at the WTRU to compress the DL CSI estimate (e.g., full raw channel or eigenvectors of the raw channel) into a low dimensional quantized-binary representation that is transmitted to the NW in the CSI feedback report, and a decoder at the NW to reconstruct the DL CSI estimate from the CSI feedback report. FIG. 2 depicts the CsiNet model architecture, which consists of convolutional layers, batch normalization layers, leaky rectified linear unit (ReLU), sigmoid activation layers, and residual connections.

The output data stage entails a reconstructed DL CSI estimate. The training stage entails training, and it may be performed online or offline in a supervised manner. The features may be either the error-free ground-truth (e.g., target) DL CSI or the real DL CSI estimate. The features may be either the full DL raw channel (e.g., for CsiNet) or the eigenvectors of the DL full raw channel (e.g., for EVCsiNet). The loss function may be the mean squared error (MSE) or the cosine similarity between the error-free ground-truth (e.g., target) DL CSI or the real DL CSI estimate (input to the encoder) and the reconstructed DL CSI (e.g., output of the decoder).

At the NW side, the NW may insert the UL side information to the NW-side AI/ML model. The NW may apply some preprocessing to the UL side information before inputting it to the NW-side model. For example, the NW may transform the UL side information into a latent representation (e.g., using an AI/ML model) and then inputs the latent representation to the AI/ML model. The NW may also have a fusion block that combines the CSI feedback message with the UL side information and inputs the resulting representation to the NW-side AI/ML model. The fusion block may be an AI/ML model.

When a WTRU is configured to use UL side information for CSI feedback enhancement, the NW may configure the key parameters. The key parameters may include SRS resource allocation information (e.g., SRS periodicity, SRS locations, SRS density, etc.). The key parameters may include pilots specific to UL side information resource allocation (e.g., periodicity, locations, density, etc.). The key parameters may include DL RS (e.g., CSI-RS) resource allocation information (e.g., RS periodicity, RS locations, RS density, etc.). The key parameters may include a CSI feedback reporting configuration. The CSI feedback reporting configuration may include reporting type (e.g., periodic, semi-persistent, or aperiodic). The CSI feedback reporting configuration may include report quantity (e.g., configuration of AI/ML-based CSI feedback report). The CSI feedback reporting configuration may include configuration of channel state feedback parameters (e.g., the number of CSI estimates used for CSI feedback reporting, CSI feedback payload, quantization parameters. etc.). The CSI feedback reporting configuration may include the signals and/or the uplink resource configuration/allocations that should carry the CSI feedback report (e.g., PUSCH, PUCCH, RRC, UCI, MAC-CE).

When the WTRU is configured to use UL side information for CSI feedback enhancement, the key parameters, that should be configured by the NW, may include NW assistance information configuration, and/or the key parameters may include statistics that quantify the UL/DL channel relation.

For UL side information for CSI feedback enhancement example signaling is described herein. An example signaling may be pilots specific to UL side information to be transmitted from the WTRU to the NW. The pilots specific to UL side information are pilot signals that may have higher density and/or power compared to SRS, and the WTRU may be configured to populate these pilot signals with a non-uniform density in the frequency domain (e.g., the closest UL subcarriers to the DL channel allocation). In a training phase, the network may configure the WTRU to use different subcarriers as the system learns to optimize the choice of subcarriers to use. An example signaling may be network assistance information to be transmitted from the NW to the WTRU. It includes some statistics and/or UL CSI feedback quantities associated to the UL CSI. The statistics and UL CSI feedback quantities that are inserted in the NW assistance information may include legacy CSI feedback components (e.g., PMI, CQI, RI, etc.,), may include either the full explicit representation of the UL CSI estimate or a compressed representation of the UL CSI estimate, and may include either the full explicit representation of the UL CSI precoder, or a compressed representation of the UL CSI precoder, or the best matched UL precoder. An example signaling may be an UL/DL channel relation feedback message to be transmitted from the WTRU to the NW as a part of the CSI feedback report. The UL/DL channel relation feedback message includes the measured statistics that quantify the relation between the UL and DL channel that is computed at WTRU based on the network assistance information received from the NW and the DL CSI information determined at the WTRU.

FIG. 5 is a diagram illustrating an example procedure 500 performed by a WTRU to measure statistics of the UL/DL channel relation and to report it to the NW. Examples of WTRU and NW procedures to exploit the UL side information for CSI feedback enhancement are described herein (e.g., the procedure 500 provides an example from the WTRU perspective). The NW can refer to any node in the network (e.g., gNB, another WTRU (e.g., sidelink, WTRU-to-WTRU direct communication), etc.).

A WTRU may receive (e.g., from NW) a request to transmit AI/ML-based CSI feedback capabilities at 502. The WTRU may transmit its capabilities to the NW by means of radio resource control (RRC) signaling. For example, the WTRU may transmit AI/ML-based CSI feedback capabilities indicating WTRU support for AI/ML-based CSI feedback reporting at 504.

The WTRU may receive a configuration information at 506 (e.g., from NW). The configuration information may include SRS resource allocation information (e.g., SRS periodicity, SRS locations, SRS density, etc.). The configuration information may include information about one or more pilots specific to UL side information resource allocation (e.g., periodicity, locations, density, etc.). The configuration information may include DL RS (e.g., CSI-RS) resource allocation information (e.g., RS periodicity, RS locations, RS density, etc.). The configuration information may include a CSI feedback reporting configuration. The CSI feedback reporting configuration may include reporting type (e.g., periodic, semi-persistent, or aperiodic). The CSI feedback reporting configuration may include report quantity (e.g., configuration of AI/ML-based CSI feedback report). The CSI feedback reporting configuration may include configuration of channel state feedback parameters (e.g., the number of CSI estimates used for CSI feedback reporting, CSI feedback payload, quantization parameters, etc.). The CSI feedback reporting configuration may include the signals and/or the uplink resource configuration/allocations that may carry the CSI feedback report (e.g., PUSCH, physical uplink control channel (PUCCH), RRC, uplink control information (UCI), medium access control-control element (MAC-CE)). The configuration information may include NW assistance information configuration. The configuration information may include metrics to measure the statistics that quantify the UL/DL channel relation.

The WTRU may receive the configuration information at 506 (e.g., from NW). The WTRU may receive the configuration through one or more of DCI, MAC-CE or RRC signaling.

The WTRU transmits SRS and pilots specific to UL side information to the NW at 508 (e.g., for UL channel sounding).

The WTRU may receive the NW assistance information from the NW at 510. The NW assistance information may include CSI feedback components (e.g., PMI, CQI, RI, etc.) of the UL channel. The NW assistance information may include either the full explicit representation of the UL CSI estimate or a compressed representation of the UL CSI estimate. The NW assistance information may include either the full explicit representation of the UL CSI precoder, or a compressed representation of the UL CSI precoder, or the best matched UL precoder. The NW assistance information may include parameters of the UL channel. The WTRU may apply preprocessing to the NW assistance information, for example, depending on the content in the NW assistance information. For example, the WTRU may reconstruct the UL CSI based on the compressed representation of the UL CSI in the NW assistance information (e.g., using configured AI/ML or non-AI/ML techniques) and/or the WTRU may reconstruct the UL precoder based on the received PMI or the compressed representation of the UL precoder in the NW assistance information (e.g., using configured AI/ML or non-AI/ML techniques).

The WTRU may receive DL RS (e.g., CSI-RS), and may generate the DL CSI information at 512. The DL CSI information may include a DL CSI estimate. The DL CSI information may include a rank of the estimated DL channel matrix. The DL CSI information may include a DL Precoder (e.g., eigenvectors), for example, obtained from the DL CSI estimate. The DL CSI information may include a CQI. The DL CSI information may include a complete DL channel.

The WTRU may determine the value of the measured statistics that quantify the UL/DL channel relation based on the NW assistance information and measurements performed on the DL RS at 514 (e.g., generated DL CSI information). The WTRU may determine a (e.g., compressed) DL CSI feedback report based on measurements performed on the DL RS (e.g., generated DL CSI information) and the determined value of the measured statistics that quantify the UL/DL channel relation at 516. The DL CSI feedback report may be generated by an AI/ML model or a hybrid AI/ML model. The WTRU may adjust some parameters of the CSI generation block based on the value of the measured statistics that quantify the UL/DL channel relation. In an example, the WTRU may determine (e.g., increase/reduce) the CSI compression ratio or may use all and/or part of the CSI feedback payload, if the value of the measured statistics that quantify the UL/DL channel relation is lower or higher than one or more threshold (e.g., thresholds that are configured by the network).

The WTRU may transmit the DL CSI feedback report to the NW at 518. The DL CSI feedback report may include the determined value of the measured statistics that quantify the UL/DL channel relation. The transmission of the DL CSI feedback report may be over resources determined from one or more of the value measured statistics that quantify the of the UL/DL channel relation and/or the parameter (e.g., compression ratio, feedback payload) of the DL CSI feedback report. The WTRU may transmit SRS and/or pilots specific to UL side information, and the configuration of the SRS and/or pilots specific to UL side information may be determined based on the value of the measured statistics that quantify the UL/DL channel relation and/or the DL CSI feedback report.

The following details an example procedure from the NW side. The NW may receive the SRS, the pilots specific to UL side information, and all available UL signals (e.g., data, demodulation reference signals, etc.), and may generate NW assistance information. The NW may estimate the UL CSI using the SRS, the pilots specific to UL side information, and all available UL signals (e.g., data, demodulation reference signals, etc.), compute UL CSI feedback quantities associated to the UL CSI, and/or include the UL CSI feedback quantities associated to the UL CSI in the NW assistance information. The UL CSI feedback quantities inserted in the NW assistance information may include CSI feedback components (e.g., PMI, CQ, RI, etc.) of the UL channel. The UL CSI feedback qualities inserted in the NW assistance information may include either the full explicit representation of the UL CSI estimate or a compressed representation of the UL CSI estimate. The UL CSI feedback qualities inserted in the NW assistance information may include either the full explicit representation of the UL CSI precoder, or a compressed representation of the UL CSI precoder, or the best matched UL precoder. The NW may transmit the NW assistance information to the WTRU. The NW may receive, from the WTRU, a DL CSI feedback report and/or the WTRU-determined value of the measured statistics that quantify the UL/DL channel relation.

The NW may determine the DL CSI estimate based on the DL CSI feedback report, the value of the measured statistics that quantify the UL/DL channel relation, the UL side information determined from SRS and/or pilots specific to UL side information, and/or UL side information determined from UL data transmission. In a first solution, the NW may input the UL DMRS and the UL data (e.g., if there is any), the NW assistance information, the SRS, the pilots specific to UL side information, and/or pilots (e.g., all pilots) present in the UL channel to its DL CSI reconstruction block. In a second solution, the NW may estimate the UL channel using UL DMRS (e.g., if there is any), the NW assistance information, the SRS, the pilots specific to UL side information, and/or pilots (e.g., all pilots) present in the UL transmission. Afterwards, the NW uses the explicit UL channel as input to DL CSI reconstruction block. The DL CSI reconstruction block may be an AI/ML model or a hybrid AI/ML model.

The NW may adjust and transmit to the WTRU the configuration of one or more of the CSI feedback payloads, the CSI feedback compression ratio, the CSI-RS allocations, the UL DMRS allocations, the SRS allocations, and/or the pilots specific to UL side information allocations based on some triggers. For example, the NW may configure the WTRU to use a specific pattern for UL pilots (e.g., SRS, pilots specific to UL side information, DMRS), in terms of pilot locations, density, and/or power. For example, the NW may configure the WTRU to use a specific UL precoder. For example, the NW may configure the WTRU to use customized grants that might cover the bandwidth of interest (e.g., the closest UL subcarriers to the DL channel allocation). The triggers may include if the WTRU-determined value of the measured statistics that quantify the UL/DL channel relation is higher or lower than one or more threshold. Accordingly, the NW may adapt (e.g., increase/reduce) the CSI feedback payload size or CSI compression ratio or the SRS and the pilots specific to UL side information allocations. The triggers may be associated with the performance feedback from the WTRU. Accordingly, the NW may increase or reduce the CSI feedback payload size, the CSI compression ratio, and/or the SRS and the pilots specific to UL side information allocations if the measured BLER is lower or higher than one or more thresholds.

Provided herein are numerical results indicating the performance evaluation of example UL side information solutions described herein. The simulations were performed via Sionna®, which is an open-source python library for the link-level simulations based on TensorFlow®. Example simulation parameters are summarized in Table 1.

TABLE 1
Simulation parameters.

| Number of Antenna at gNB | 16 | |
|---|---|---|
| Number of Antenna at WTRU | 2 | |
| Number of Layers L | 2 | |
| Channel Model | CDL-B | |
| Carrier Frequency | UL Carrier Frequency: 1.9 GHz | |
| | DL Carrier Frequency: 2.1 GHz | |
| Delay Spread | 300 | ns |
| DL/UL Duplex Mode | FDD | |
| WTRU Velocity | 5 | m/s |
| Subcarrier Spacing | 15 | kHz |
| Number of Subcarriers | 667 | |
| Bandwidth | 10 | MHz |
| CSI Type | Full raw channel | |
| CSI-RS periodicity | 5 | ms |

| | |
|---|---|
| Number of latent variables | (payload size)/2 |
| Quantization | Scalar quantization with 2 bits |
| | per latent variable |

The AI/ML models were trained with CSI data generated on the fly for 200 runs, where each run included 500 consecutive time slots, and a batch of 300 raw channel matrices per time slot. To evaluate the performance of the example UL side information solutions, the UL side information solution was compared to a conventional AI/ML-based CSI feedback reporting mechanism (e.g., as a baseline). Specifically, the spatial/frequency (SF) CSI compression was considered as a CSI feedback enhancement use case. The baseline is SF CSI compression without UL side information. The proposed solution may be SF CSI compression with UL side information.

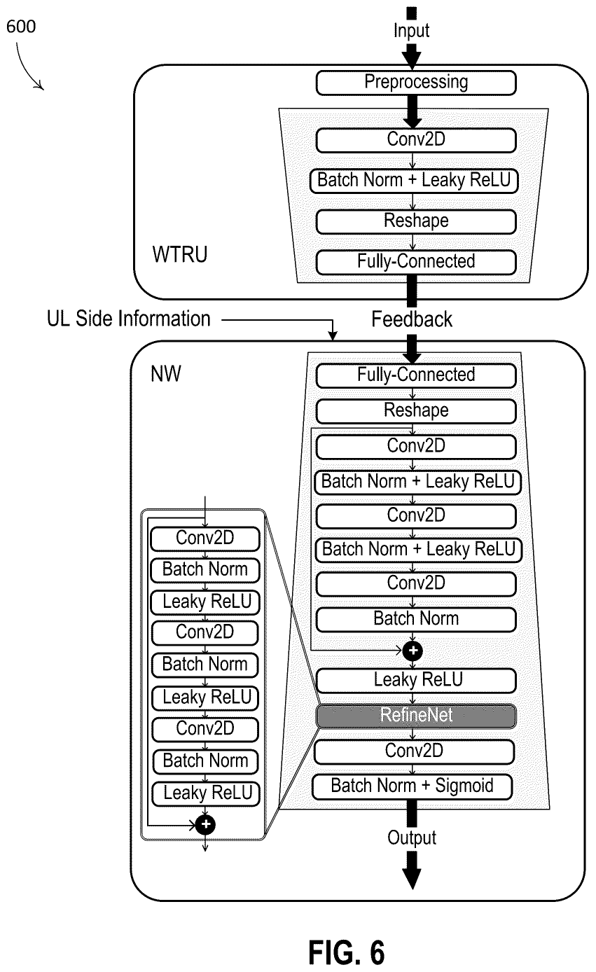

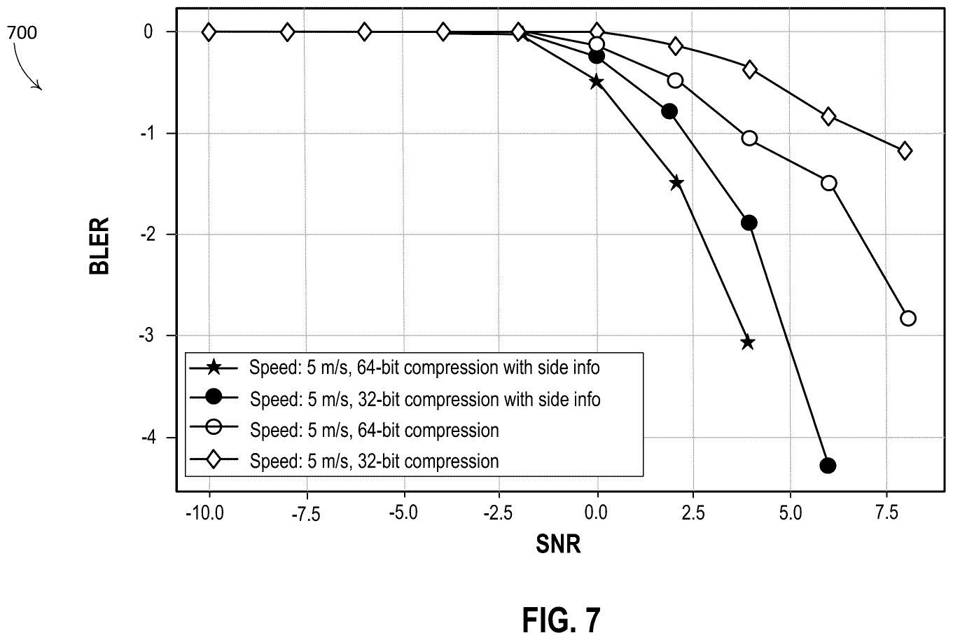

FIG. 6 is a diagram 600 illustrating an example CsiNet model architecture, with the UL side information added as input to the NW-side AI/ML model. FIG. 7 is a diagram 700 illustrating an example block error rate (BLER) vs signal-to-noise ratio (SNR) for SF CSI compression with and without UL side information. FIG. 7 presents the BLER performance versus signal-to-noise-ratio (SNR) for the SF CSI compression use cases based on the UL side information solutions described herein (e.g., with UL side information) and use cases based on the baseline (e.g., without UL side information) for payload sizes of 32 and 64 bits. FIG. 7 demonstrates the gain resulting from including the UL side information at the NW-side AI/ML model, as proposed herein. For instance, as shown in FIG. 7, for a target BLER of 0.1 (−1 dB), the UL side information solutions described herein provide around 5 dB SNR gain compared to the baseline. Moreover, for a target BLER of 0.01 (−2 dB), the UL side information solutions described herein provide around 4 dB SNR gain compared to the baseline.

1. A wireless transmit/receive unit (WTRU) comprising:
a processor configured to:
receive network assistance information;
determine a downlink channel state information (CSI) based one on more downlink reference signals (RSs);
determine a value associated with an uplink/downlink (UL/DL) channel relation based on the network assistance information and measurements performed on the one or more downlink RSs; and
send a CSI feedback report, wherein the CSI feedback report is based on the measurements performed on the one or more downlink RSs and/or the value of the measured statistics that quantify the UL/DL channel relation.

2. The WTRU of claim 1, wherein the associated value that quantifies UL/DL channel relation indicates a relation between an uplink channel and a downlink channel associated with the one or more downlink RSs.

3. The WTRU of claim 1, wherein the processor is configured to adjust one or more parameters used to generate the CSI feedback report based on a comparison between the associated value that quantifies the UL/DL channel relation and one or more thresholds.

4. The WTRU of claim 1, wherein the processor is configured to determine a CSI compression ratio for the CSI feedback report based on the associated value that quantifies the UL/DL channel relation.

5. The WTRU of claim 1, wherein the processor is configured to determine an amount of CSI feedback payload for the CSI feedback report based on the associated value that quantifies the UL/DL channel relation.

6. The WTRU of claim 1, wherein the CSI feedback report may include the associated value that quantifies the UL/DL channel relation.

7. The WTRU of claim 1, wherein the processor is configured to generate the CSI feedback report via an artificial intelligence/machine learning (AI/ML) model.

8. The WTRU of claim 1, wherein the one or more pilots associated with uplink information provide an indication of a downlink channel, and wherein the one or more pilots are selected by a network and the configuration information indicates how the WTRU is to use the one or more pilots.

9. The WTRU of claim 1, wherein the network assistance information comprises one or more CSI feedback components associated with an uplink channel, a compressed representation of a CSI estimate associated with the uplink channel, and one or more parameters associated with the uplink channel.

10. The WTRU of claim 1, wherein the downlink CSI comprises an indication of one or more of (i) a downlink CSI estimate, (ii) a rank associated with the downlink CSI estimate, (iii) one or more eigenvectors associated with the downlink CSI estimate, (iv) a channel quality indicator (CQI), or (v) a complete DL channel.

11. A method implemented in a wireless transmit/receive unit (WTRU), the method comprising:
receiving network assistance information;
determining a downlink channel state information (CSI) based one on more downlink reference signals (RSs);
determining a value associated with an uplink/downlink (UL/DL) channel relation based on the network assistance information and measurements performed on the one or more downlink RSs; and
sending a CSI feedback report, wherein the CSI feedback report is based on the measurements performed on the one or more downlink RSs and/or the value of the measured statistics that quantify the UL/DL channel relation.

12. The method of claim 11, wherein the associated value that quantifies UL/DL channel relation indicates a relation between an uplink channel and a downlink channel associated with the one or more downlink RSs.

13. The method of claim 11, further comprising adjusting one or more parameters used to generate the CSI feedback report based on a comparison between the associated value that quantifies the UL/DL channel relation and one or more thresholds.

14. The method of claim 11, further comprising determining a CSI compression ratio for the CSI feedback report based on the associated value that quantifies the UL/DL channel relation.

15. The method of claim 11, further comprising determining an amount of CSI feedback payload for the CSI feedback report based on the associated value that quantifies the UL/DL channel relation.

16. The method of claim 11, wherein the CSI feedback report may include the associated value that quantifies the UL/DL channel relation.

17. The method of claim 11, further comprising generating the CSI feedback report via an artificial intelligence/machine learning (AI/ML) model.

18. The method of claim 11, wherein the one or more pilots associated with uplink information provide an indication of a downlink channel, and wherein the one or more pilots are selected by a network and the configuration information indicates how the WTRU is to use the one or more pilots.

19. The method of claim 11 wherein the network assistance information comprises one or more CSI feedback components associated with an uplink channel, a compressed representation of a CSI estimate associated with the uplink channel, and one or more parameters associated with the uplink channel.

20. The method of claim 11, wherein the downlink CSI comprises an indication of one or more of (i) a downlink CSI estimate, (ii) a rank associated with the downlink CSI estimate, (iii) one or more eigenvectors associated with the downlink CSI estimate, (iv) a channel quality indicator (CQI), or (v) a complete DL channel.
